(19) United States
(12) Patent Application Publication
(10) Pub. No.: US 2021/0402573 A1
(43) Pub. Date: Dec. 30, 2021

(54) Adjustable Wrench

(71) Applicant: Hui-Chen Chang, New Taipei City (TW)

(72) Inventor: Wang-Lien Chang, New Taipei City (TW)

(21) Appl. No.: 17/191,859

(22) Filed: Mar. 4, 2021

(30) Foreign Application Priority Data
Jun. 29, 2020 (TW) 109208241

(51) Int. Cl. B25B 13/14; B25G 1/10

(52) U.S. Cl. CPC B25B 13/14; B25G 1/105

(57) ABSTRACT

An adjustable wrench has a handle assembly and a gripping assembly. The handle assembly includes a rotating handle, a pivot shaft, and a holding handle. The pivot shaft is securely mounted in the rotating handle, and has a right-handed screw thread and a left-handed screw thread. The holding handle is mounted around the pivot shaft. The gripping assembly includes a base, a lower jaw, an upper jaw, and a guiding module. The lower jaw engages with the left-handed screw thread of the pivot shaft. The upper jaw engages with the right-handed screw thread of the pivot shaft. The guiding module is slidably mounted through the base and the lower jaw and is securely connected to the upper jaw. By turning the rotating handle as well as the pivot shaft, the upper jaw and the lower jaw can be quickly moved to a closed state or an open state.

### CROSS-REFERENCE TO RELATED APPLICATIONS

This application is based upon and claims priority under 35 U.S.C. 119 from Taiwan Patent Application No. 109208241 filed on Jun. 29, 2020, which is hereby specifically incorporated herein by this reference thereto.

### BACKGROUND OF THE INVENTION

### 1. Field of the Invention

The present invention relates to a wrench, especially to an adjustable wrench, especially to an adjustable wrench that changes a distance between two jaws by turning a rotatable handle assembly.

### 2. Description of the Prior Art(s)

A conventional wrench, especially an adjustable wrench, has a handle and a head. The handle is rod-shaped. The head is assembled on a top end of the handle and includes a fixed jaw, an adjusting screw, and a movable jaw. The fixed jaw is mounted on the top end of the handle and is immobile. The adjusting screw is rotatably mounted in the top end of the handle. The movable jaw is slidably mounted on the top end of the handle and has multiple formed on a bottom of the movable jaw and engaging with the adjusting screw. When the adjusting screw is turned, the movable jaw is driven to move toward or away from the fixed jaw, such that a distance between the movable jaw and the fixed jaw can be adjusted to fit nuts for a variety of sizes.

However, since a size of the conventional adjustable wrench is limited, the adjusting screw is limited to a small size accordingly. Therefore, when a user intends to drastically change the distance between the movable jaw and the fixed jaw, the adjusting screw has to be turned many times, which is time consuming and inefficient.

To overcome the shortcomings, the present invention provides an adjustable wrench to mitigate or obviate the aforementioned problems.

### SUMMARY OF THE INVENTION

The main objective of the present invention is to provide an adjustable wrench that has a handle assembly and a gripping assembly.

The handle assembly includes a rotating handle, a pivot shaft, and a holding handle. The rotating handle is tubular and has an axial passage formed through the rotating handle. The pivot shaft has an upper section, a lower section, a right-handed screw thread, and a left-handed screw thread. The lower section is securely mounted in the rotating handle. The right-handed screw thread and the left-handed screw thread are separately formed on an outer side surface of the pivot shaft and are disposed on the upper section of the pivot shaft. The holding handle is tubular, is mounted around the upper section of the pivot shaft, and has a lower end protruding in the rotating handle and an upper end provided with a connecting portion.

The gripping assembly includes a base, a lower jaw, an upper jaw, and a guiding module. The base is securely mounted on the holding handle and has a connecting hole formed through the base. The connecting portion of the holding handle protrudes in the connecting hole and is connected with the base. The lower jaw is securely mounted on the base and has a lower threaded hole formed through the lower jaw and mounted around the upper section of the pivot shaft. The lower jaw engages with the left-handed screw thread of the pivot shaft. The upper jaw has an upper threaded hole formed through the upper jaw and mounted around the upper section of the pivot shaft. The upper jaw engages with the right-handed screw thread of the pivot shaft. The guiding module is slidably mounted through the base and the lower jaw and has an end portion securely connected to the upper jaw.

By turning the rotating handle as well as the pivot shaft, the upper jaw and the lower jaw can be quickly moved to a closed state or an open state. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable wrench in accordance with the present invention, showing the adjustable wrench being in a closed state;

FIG. 2 is an exploded perspective view of the adjustable wrench in FIG. 1;

FIG. 3 is another exploded perspective view of the adjustable wrench in FIG. 1;

FIG. 4 is a cross-sectional side view of the adjustable wrench in FIG. 1;

FIG. 5 is an enlarged cross-sectional side view of the adjustable wrench in FIG. 1, showing the adjustable wrench being in the closed state;

FIG. 6 is another enlarged cross-sectional side view of the adjustable wrench in FIG. 1, showing the adjustable wrench being in an open state; and

FIG. 7 is another perspective view of the adjustable wrench in FIG. 1, showing the adjustable wrench being in the open state.

### DETAILED DESCRIPTION OF THE PREFERRED EMBODIMENTS

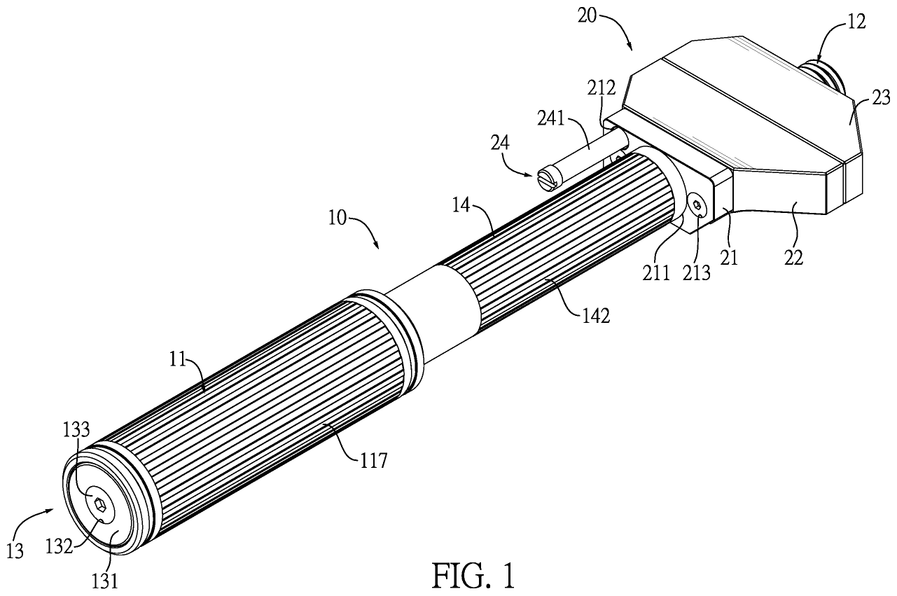

With reference to FIG. 1, an adjustable wrench in accordance with the present invention comprises a handle assembly 10 and a gripping assembly 20.

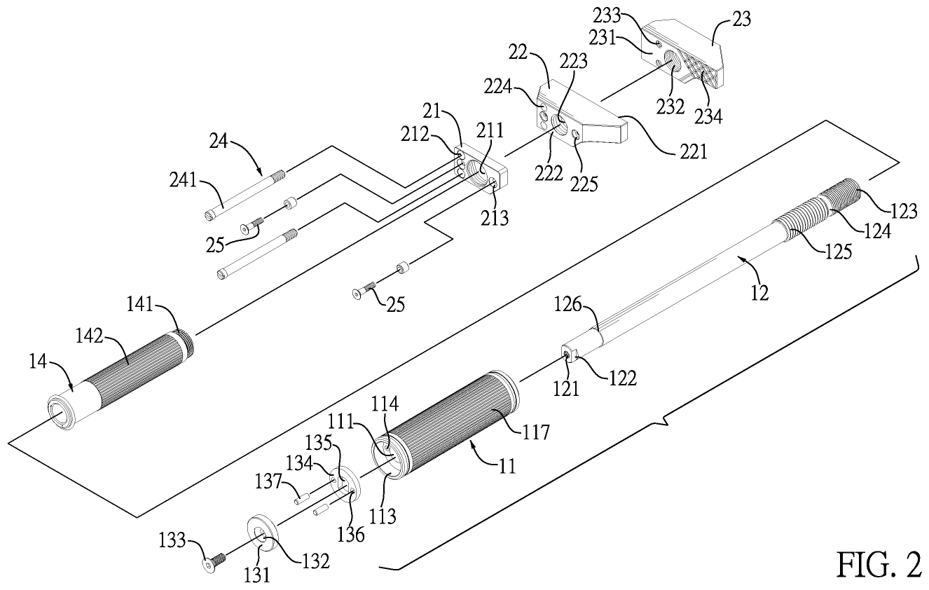

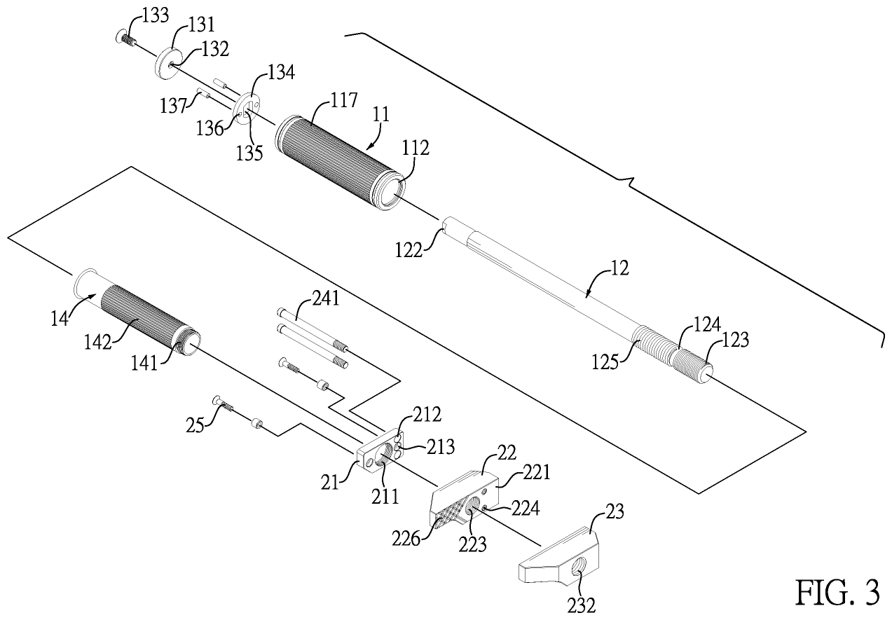

With further reference to FIGS. 2 to 4, the handle assembly 10 includes a rotating handle 11, a pivot shaft 12, a securing module 13, and a holding handle 14. The rotating handle 11 is substantially tubular and has an upper combining recess 112, a lower combining recess 113, an axial passage 111, multiple fixing recesses 114, a stop protrusion 115, an internal annular groove 116, and an anti-slip portion 117.

The upper combining recess 112 and the lower combining recess 113 are formed in two opposite end surfaces of the rotating handle 11. The axial passage 111 is formed through the rotating handle 11, is disposed between the upper combining recess 112 and the lower combining 113, extends along an axial line of the rotating handle 11, and communicates with the upper combining recess 112 and the lower combining 113. An inner side surface of the rotating handle 11 is defined around the axial passage 111. The fixing recesses 114 are separately formed in a bottom defined in the lower recess 113.

The stop protrusion 115 of the rotating handle 11 is formed on the inner side surface of the rotating handle 11. The internal annular groove 116 is formed in an inner sidewall defined around the upper combining recess 112. A holding ring 15 is mounted in and around the internal annular groove 116. The anti-slip portion 117 of the rotating handle 11 is formed on an outer sidewall of the rotating handle 11. In the preferred embodiment, the anti-slip portion 117 of the rotating handle 11 includes multiple elongated recesses separately arranged around the outer sidewall of the rotating handle 11. Each of the elongated recesses of the anti-slip portion 117 of the rotating handle 11 extends parallel to the axial line of the rotating handle 11.

The pivot shaft 12 has an outer side surface, an upper section, a lower section, an engaging end 122, a threaded hole 121, a right-handed screw thread 123, a left-handed screw thread 125, an external annular groove 124, and a stop protrusion 126.

The lower section of the pivot shaft 12 is securely mounted in the rotating handle 11. The engaging end 122 is defined at the lower section of the pivot shaft 12 and is non-circular in cross-section. A lower end surface of the pivot shaft 12 is defined on the engaging end 122. The threaded hole 121 is axially formed in the lower end surface of the pivot shaft 12.

The right-handed screw thread 123 and the left-handed screw thread 125 are separately formed on the outer side surface of the pivot shaft 12 and are disposed on the upper section of the pivot shaft 12.

The external annular groove 124 is formed in the outer side surface of the pivot shaft 12 and is disposed between the right-handed screw thread 123 and the left-handed screw thread 125. In the preferred embodiment, the right-handed screw thread 123 is disposed between the left-handed screw thread 123 and an upper end surface of the pivot shaft 12. The stop protrusion 126 of the pivot shaft 12 is formed on the outer side surface of the pivot shaft 12 and abuts against the stop protrusion 115 of the rotating handle 11.

The securing module 13 is mounted in the lower combining recess 113 of the rotating handle 11, connects the rotating handle 11 and the pivot shaft 12, and includes a locking pad 134, multiple fixing pins 137, a fastening pad 131, and a fastening screw 133.

The locking pad 134 is mounted in the lower combining recess 113 and has an engaging hole 135 and multiple through holes 136. The engaging hole 135 is non-circular. The engaging end 122 of the pivot shaft 12 is engaged in the engaging hole 135 of the locking pad 134. In the preferred embodiment, the engaging hole 135 corresponds in shape to the engaging end 122 of the pivot shaft 12. The through holes 136 align with the fixing recesses 114 of the rotating handle 11 respectively. The fixing pins 137 are mounted through the through holes 136 of the locking pad 134 respectively and are inserted into the fixing recesses 114 of the rotating handle 11 respectively. In the preferred embodiment, the multiple fixing recesses 114 of the rotating handle 11 include two fixing recesses 114, the through holes 136 of the locking pad 134 include two through holes 136, and the multiple fixing pins 137 include two fixing pins 137.

The fastening pad 131 is mounted in the lower combining recess 113 and has a mounting hole 132. The locking pad 134 is held between the fastening pad 131 and the bottom defined in the lower recess 113. The fastening screw 133 is mounted through the mounting hole 132 of the fastening pad 131 and is engaged in the threaded hole 121 of the pivot shaft 12. Thus, the pivot shaft 12 rotates along with the rotating handle 11 and is unable to rotate relative to the rotating handle 11.

The holding handle 14 is tubular, is mounted around the upper section of the pivot shaft 12, and has a lower end, an upper end and an anti-slip portion 142. The lower end of the holding handle 14 protrudes in the upper combining recess 112 of the rotating handle 11 with the holding ring 15 abutting against an outer side surface of the holding handle 14. The upper end of the holding handle 14 is provided with a connecting portion 141. The anti-slip portion 142 of the holding handle 14 is formed on the outer side surface of the holding handle 14. In the preferred embodiment, the anti-slip portion 142 of the holding handle 14 includes multiple elongated recesses separately arranged around the outer side surface of the holding handle 14. Each of the elongated recesses of the anti-slip portion 142 of the holding handle 14 extends parallel to an axial line of the holding handle 14.

The gripping assembly 20 includes a base 21, a lower jaw 22, an upper jaw 23, and a guiding module 24.

The base 21 is formed as a block, is securely mounted on the upper end of the holding handle 14, and has a connecting hole 211, multiple guiding holes 212, and multiple mounting holes 213. The connecting hole 211 is formed through the base 21. The connecting portion 141 of the holding handle 14 protrudes in the connecting hole 211 and is connected with the base 211. In the preferred embodiment, the connecting portion 141 of the holding handle 14 is formed as external thread and an internal thread is formed around the connecting hole 211. The connecting portion 141 of the holding handle 14 is connected with the base 211 via the external thread on the upper end of the holding handle 14 and the internal thread around the connecting hole 211. The guiding holes 212 are separately formed through the base 21 and are disposed on a same side of the connecting hole 211. In the preferred embodiment, the multiple guiding holes 212 include two guiding holes 212. The mounting holes 213 of the base 21 are separately formed through the base 21 and are disposed on opposite sides of the connecting hole 211 respectively.

The lower jaw 22 is formed as a block, is securely mounted on the base 21, and has a moving gripping surface 221 and a lower combining surface 222. The moving gripping surface 221 is formed on a top of the lower jaw 22 and is flat. The lower combining surface 222 is formed on a bottom of the lower jaw 22. The lower jaw 22 further has a lower threaded hole 223, multiple lower guiding holes 224, and multiple fastening holes 225. The lower threaded hole 223 is formed through the lower jaw 22, is mounted around the upper section of the pivot shaft 12, and is provided with an internal left-handed screw thread for engaging with the left-handed screw thread 125 of the pivot shaft 12. The lower guiding holes 224 are separately formed through the lower jaw 22 and align with the guiding holes 212 of the base 21 respectively. In the preferred embodiment, the multiple lower guiding holes 224 include two lower guiding holes 224. The fastening holes 225 of the lower jaw 22 are formed in the lower combining surface 222 of the lower jaw 22 and align with the mounting holes 213 of the base 21 respectively. Each of the fastening holes 225 of the lower jaw 22 is provided with an internal thread. Multiple screws 25 are slidably mounted through the mounting holes 213 of the base 21 respectively and protrude in and are engaged in the fastening holes 225 of the lower jaw 22 respectively, such that the lower jaw 22 is securely mounted on the base 21.

The upper jaw 23 is formed as a block and has a stationary gripping surface 231 formed on a bottom of the upper jaw 23. The upper jaw 23 further has an upper threaded hole 232 and multiple fastening holes 233. The upper threaded hole 232 is formed through the upper jaw 23, is mounted around the upper section of the pivot shaft 12, and is provided with an internal right-handed screw thread for engaging with the right-handed screw thread 123 of the pivot shaft 12. The fastening holes 233 of the upper jaw 23 are separately formed in the stationary gripping surface 231 and align with the lower guiding holes 224 of the lower jaw 22 respectively. Each of the fastening holes 233 of the upper jaw 23 is provided with an internal thread.

In the preferred embodiment, the moving gripping surface 221 of the lower jaw 22 is provided with multiple notches 226 and the stationary gripping surface 231 of the upper jaw 23 is also provided with multiple notches 234.

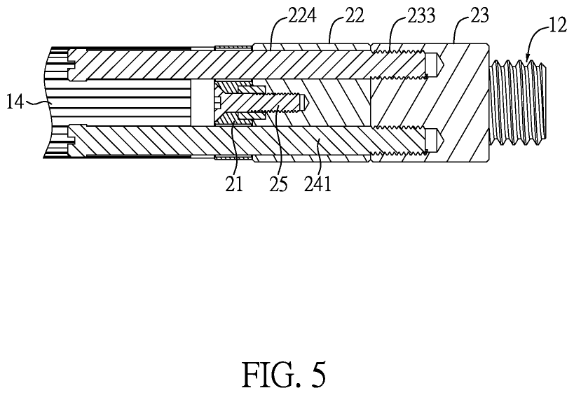

With further reference to FIG. 5, the guiding module 24 is slidably mounted through the base 21 and the lower jaw 22 and has an end portion securely connected to the upper jaw 23. Specifically, the guiding module 24 includes multiple guiding rods 241. The guiding rods 241 are slidably mounted through the guiding holes 212 of the base 21 respectively, are slidably mounted through the lower guiding holes 224 of the lower jaw 22 respectively, protrude in the fastening holes 233 of the upper jaw 23 respectively, and are securely connected with the upper jaw 23. Each of the guiding rods 241 has an upper end provided with an external thread. The upper end of the guiding rod 241 is connected with the upper jaw 23 via the external thread on the upper end of the guiding rod 241 and the internal thread in a corresponding one of the fastening holes 233 of the upper jaw 23. In the preferred embodiment, the multiple guiding rods 241 include two guiding rods 241. With the guiding rods 241 sliding in the lower guiding holes 224 of the lower jaw 22, the lower jaw 22 is able to be stably moved toward or away from the upper jaw 23.

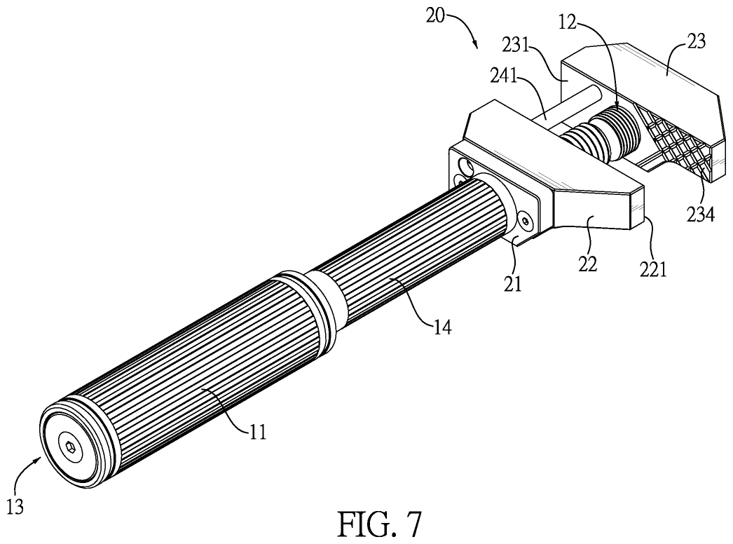

The adjustable wrench of the present invention can be adjusted to a closed state as shown in FIG. 1 or an open state as shown in FIG. 7.

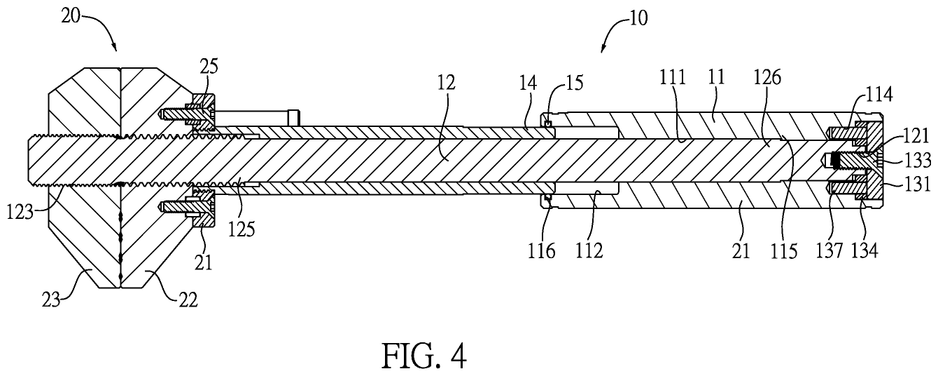

With further reference to FIGS. 4 and 5, when the adjustable wrench of the present invention is in the closed state, the lower end of the holding handle 14 protrudes in the upper combining recess 112 of the rotating handle 11, and the moving gripping surface 221 of the lower jaw 22 abuts against the stationary gripping surface 231 of the upper jaw 23 and is disposed adjacent to the external annular groove 124 of the pivot shaft 12.

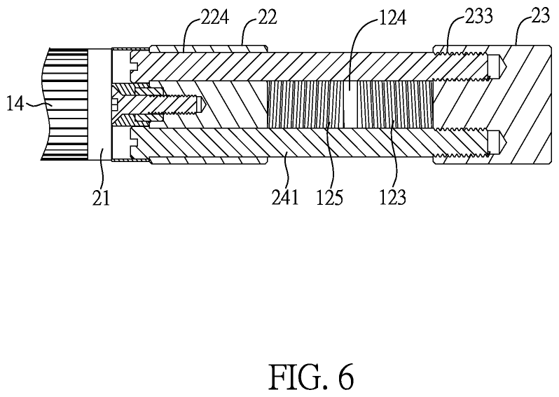

With further reference to FIG. 6, when adjusting the adjustable wrench of the present invention to the open state, a user holds the rotating handle 11 with one hand, holds the holding handle 14 with another hand, and the turns the rotating handle 11 clockwise to allow the rotating handle 11 to rotate relative to the holding handle 14. Meanwhile, the pivot shaft 12 rotates accordingly.

When the pivot shaft 12 rotates clockwise, the lower jaw 22 that engages with the pivot shaft 12 via the internal left-handed screw thread and the left-handed screw thread 125 and the upper jaw 23 that engages with the pivot shaft 12 via the internal right-handed screw thread and the right-handed screw thread 123 move toward opposite directions. That is, the lower jaw 22 moves toward the rotating handle 11 and the upper jaw 23 moves toward the upper end surface of the pivot shaft 12. Thus, an interval is formed between the moving gripping surface 221 of the lower jaw 22 and the stationary gripping surface 231 of the upper jaw 23, as shown in FIG. 7. The interval between the lower jaw 22 and the upper jaw 23 can be adjusted according to the user's needs.

In the aforementioned process, since the upper jaw 23 and the lower jaw 22 are moved by turning the rotating handle 11, the interval between the lower jaw 22 and the upper jaw 23 can be adjusted quickly. The adjustable wrench of the present invention can be adjusted to the closed state or the open state quickly.

In the aforementioned process, with the anti-slip portion 117 on the rotating handle 11 and the anti-slip portion 142 on the holding handle 14, the user can hold the rotating handle 11 and the holding handle 14 with his/her two hands stably. The hand of the user does not slip on the rotating handle 11.

Moreover, with the notches 226 on the moving gripping surface 221 of the lower jaw 22 and the notches 234 on the stationary gripping surface 231 of the upper jaw 23, the lower jaw 22 and the upper jaw 23 can stably grip fasteners, such as nuts and bolts.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable wrench comprising:
a handle assembly including
a rotating handle being tubular and having an axial passage, and the axial passage formed through the rotating handle;
a pivot shaft having
an upper section;
a lower section securely mounted in the rotating handle; and
a right-handed screw thread and a left-handed screw thread, and the right-handed screw thread and the left-handed screw thread separately formed on an outer side surface of the pivot shaft and disposed on the upper section of the pivot shaft; and
a holding handle being tubular, mounted around the upper section of the pivot shaft, and having
a lower end protruding in the rotating handle; and
an upper end provided with a connecting portion; and
a gripping assembly including
a base securely mounted on the holding handle and having a connecting hole, and the connecting hole formed through the base, wherein the connecting portion of the holding handle protrudes in the connecting hole and is connected with the base;
a lower jaw securely mounted on the base and having a lower threaded hole, and the lower threaded hole formed through the lower jaw and mounted around the upper section of the pivot shaft, wherein the lower jaw engages with the left-handed screw thread of the pivot shaft;
an upper jaw having an upper threaded hole, and the upper threaded hole formed through the upper jaw and mounted around the upper section of the pivot shaft, wherein the upper jaw engaging with the right-handed screw thread of the pivot shaft; and
a guiding module slidably mounted through the base and the lower jaw and having an end portion securely connected to the upper jaw.

2. The adjustable wrench as claimed in claim 1, wherein
the connecting portion of the holding handle is formed as external thread;
an internal thread is formed around the connecting hole;
the connecting portion of the holding handle is connected with the base via the external thread on the upper end of the holding handle and the internal thread around the connecting hole.

3. The adjustable wrench as claimed in claim 2, wherein
the rotating handle has a stop protrusion formed on an inner side surface of the rotating handle; and
the pivot shaft has a stop protrusion formed on the outer side surface of the pivot shaft and abutting against the stop protrusion of the rotating handle.

4. The adjustable wrench as claimed in claim 2, wherein
the rotating handle has
an upper combining recess formed in one of two opposite end surfaces of the rotating handle; and
an internal annular groove formed in an inner sidewall defined around the upper combining recess, wherein a holding ring is mounted in and around the internal annular groove; and
the lower end of the holding handle protrudes in the upper combining recess of the rotating handle with the holding ring abutting against an outer side surface of the holding handle.

5. The adjustable wrench as claimed in claim 1, wherein
the rotating handle has a lower combining recess formed in one of the two opposite end surfaces of the rotating handle and being opposite to the upper combining recess; and
the handle assembly includes a securing module mounted in the lower combining recess of the rotating handle and connecting the rotating handle and the pivot shaft.

6. The adjustable wrench as claimed in claim 5, wherein
the rotating handle has multiple fixing recesses separately formed in a bottom defined in the lower recess;
the pivot shaft has
an engaging end defined at the lower section of the pivot shaft and being non-circular in cross-section, wherein a lower end surface of the pivot shaft is defined on the engaging end; and
a threaded hole axially formed in the lower end surface of the pivot shaft; and
the securing module includes
a locking pad mounted in the lower combining recess and having
an engaging hole being non-circular, wherein the engaging end of the pivot shaft is engaged in the engaging hole of the locking pad; and
multiple through holes aligning with the fixing recesses of the rotating handle respectively;
multiple fixing pins mounted through the through holes of the locking pad respectively and inserted into the fixing recesses of the rotating handle respectively;
a fastening pad mounted in the lower combining recess and having a mounting hole, wherein the locking pad is held between the fastening pad and the bottom defined in the lower recess; and
a fastening screw mounted through the mounting hole of the fastening pad and engaged in the threaded hole of the pivot shaft.

7. The adjustable wrench as claimed in claim 1, wherein
the base multiple guiding holes;
the lower jaw has
a moving gripping surface formed on a top of the lower jaw and being flat;
a lower combining surface formed on a bottom of the lower jaw; and
multiple lower guiding holes separately formed through the lower jaw and aligning with the guiding holes of the base respectively;
the upper jaw has
a stationary gripping surface formed on a bottom of the upper jaw; and
multiple fastening holes separately formed in the stationary gripping surface and aligning with the lower guiding holes of the lower jaw respectively; and
the guiding module including multiple guiding rods slidably mounted through the guiding holes of the base respectively, slidably mounted through the lower guiding holes of the lower jaw respectively, protruding in the fastening holes of the upper jaw respectively, and securely connected with the upper jaw.

8. The adjustable wrench as claimed in claim 7, wherein
the moving gripping surface of the lower jaw is provided with multiple notches; and
the stationary gripping surface of the upper jaw is also provided with multiple notches.

9. The adjustable wrench as claimed in claim 1, wherein
the rotating handle has an anti-slip portion formed on an outer sidewall of the rotating handle; and
the holding handle has an anti-slip portion formed on an outer side surface of the holding handle.

10. The adjustable wrench as claimed in claim 9, wherein
the anti-slip portion of the rotating handle includes multiple elongated recesses separately arranged around the outer sidewall of the rotating handle, and each of the elongated recesses of the rotating handle extends parallel to an axial line of the rotating handle; and
the anti-slip portion of the holding handle includes multiple elongated recesses separately arranged around the outer sidewall of the holding handle, and each of the elongated recesses of the holding handle extends parallel to an axial line of the holding handle.
